(19) United States
(12) Patent Application Publication
(10) Pub. No.: US 2025/0138825 A1
(43) Pub. Date: May 1, 2025

(54) PREFETCHING PROGRAM CODE FROM FLASH MEMORY BASED ON BRANCH LOGIC

(71) Applicant: TEXAS INSTRUMENTS INCORPORATED, Dallas, TX (US)

(72) Inventors: Veeramanikandan Raju, Bangalore (IN); Mihir Mody, Bangalore (IN); Shailesh Ghotgalkar, Bangalore (IN)

(21) Appl. No.: 18/498,423

(22) Filed: Oct. 31, 2023

(51) Int. Cl. G06F 9/30; G06F 11/07

(52) U.S. Cl. CPC G06F 9/30047; G06F 11/0793

(57) ABSTRACT

A system for prefetching program code from flash memory that includes processing circuitry configured to execute program code and prefetch circuitry coupled to the processing circuitry. In an implementation, the prefetch circuitry is configured to analyze branch logic within the program code to identify a block of code to prefetch from flash memory. Once identified, the prefetch circuitry causes the block of code to be prefetched from flash memory and loaded to a memory buffer. In another implementation, the prefetch circuitry is further configured to receive a request to supply the processing circuitry with the block of code. Upon receiving the request, the prefetch circuitry determines that the block of code has already been fetched and loaded in the memory buffer. Once identified in the memory buffer, the prefetch circuitry causes the block of code to be supplied to the processing circuitry.

### TECHNICAL FIELD

Aspects of the disclosure are related to the field of computing hardware, and in particular, to embedded processors with prefetching capabilities.

### BACKGROUND

Embedded systems are electronic devices that use microcontrollers or processors to perform dedicated tasks in the context of a variety of applications. Microcontrollers and processors enable embedded applications across numerous industries such automotive, manufacturing, and the like. Embedded applications are typically executed from system memory (e.g., static random-access memory (SRAM)) by the processing resources of an embedded device, examples of which include central processing units (CPUs), digital signal processors (DSPs), and the like. In some cases, program code (e.g., instructions and associated data) is executed directly from flash memory, rather than system memory, in a strategy that is referred to as execute-in-place (XIP).

One advantage to executing-in-place is the low price of flash memory relative to SRAM. One drawback is that executing-in-place from flash is slow relative to executing from SRAM. Prefetching is one technique that is used to speed-up executing-in-place from flash where a prefetch engine on a flash controller fetches program code ahead of the code being requested by a CPU. However, current techniques prefetch program code in a strictly linear fashion which is wasteful and inefficient when the application being executed by the CPU jumps around in a non-linear fashion for substantial periods of time.

### SUMMARY

Technology disclosed herein includes an embedded system capable of prefetching program code from flash memory based on branch logic expressed in the prefetched program code, thereby improving the speed of XIP strategies. In various implementations, an embedded system is described herein that includes processing circuitry configured to execute program code and prefetch circuitry configured to prefetch program code for the processing circuitry. In operation, the processing circuitry requests for program code that is serviced by the prefetch circuitry. The prefetch circuitry includes a memory buffer configured to store prefetched program code and branch prediction circuitry configured to analyze branch logic of the prefetched program code. In an implementation the prefetch circuitry is coupled to a flash controller and instructs the flash controller to prefetch program code from flash memory based on the output of the branch prediction circuitry.

In one example embodiment, the branch prediction circuitry analyzes branch logic in the program code to identify a block of code to prefetch from the flash memory. When identified, the branch prediction circuitry causes the prefetch circuitry to prefetch the block of code from flash memory and load the block of code to the memory buffer. In an implementation, the prefetch circuitry causes the flash controller to prefetch the block of code when the flash controller is idle.

In another example embodiment, the prefetch circuitry receives a request to supply the processing circuitry with a block of code. In response, the prefetch circuitry determines if the block of code has already been fetched and loaded to the memory buffer. If the block of code has already been prefetched, the prefetch circuitry causes the block of code to be supplied to the processing circuitry. Alternatively, if the block of code has not already been prefetched, then the prefetch circuitry causes the block of code to be fetched from flash memory and supplied to the processing circuitry.

In an implementation the prefetch circuitry includes fault prediction circuitry configured to detect faults in a requested block of code. If a potential fault is detected, the fault prediction circuitry alerts the processing circuitry of the potential fault. The processing circuitry may mitigate or otherwise take action accordingly.

This Summary is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modification's, and equivalents.

FIG. 1 illustrates an operational system in an implementation.

FIGS. 2A and 2B illustrate a method of prefetching in an implementation.

FIG. 3 illustrates an operational sequence in an implementation.

FIG. 4 illustrates a prefetcher system in an implementation.

FIGS. 5A and 5B illustrate a prefetching process in an implementation.

FIG. 6 illustrates an operational sequence in an implementation.

FIG. 7 illustrates an operational scenario in an implementation.

### DETAILED DESCRIPTION

Technology is disclosed herein that provides a dynamic method of prefetching from flash memory based on branch logic analysis that improves the speed and efficiency of execute-in-place strategies with respect to embedded applications. Generally speaking, during execute-in-place, a portion of code of an embedded application is loaded from flash memory to an on-chip cache of a CPU without being stored in system memory, such as SRAM, in the interim. In some implementations, the portion of code may be a “burst” having a size equal to that of the CPU's cache line size. The CPU executes the code until it needs another portion that has not yet been loaded to the cache. The CPU communicates with a flash memory controller to obtain the new portion of code.

The flash controller obtains the code from flash memory and provides it to the CPU. To speed-up this process, the flash controller may prefetch the code. That is, the flash controller may fetch a block of code ahead of it being requested by the CPU, so that the code can be provided to the CPU immediately upon request. As discussed above, previous techniques for prefetching operated in a generally linear manner. In contrast, in some examples, program code is prefetched based on branch logic expressed in the code, allowing portions of code to be prefetched that are more likely to be requested by the CPU as it executes the logic of the embedded application.

In particular, a prefetch engine is disclosed herein that analyzes branch logic expressed in program code to determine which portions of code to prefetch. Branch logic refers to any instructions that may alter the order in which instructions are executed and, for a given instruction set architecture, such instructions may be referred to as branch instructions, loop instructions, jump instructions, return instructions, and/or other suitable instructions. The prefetch engine may be implemented in the context of a flash controller that provides an interface between CPUs requesting code and the flash memory resources on which the code is stored. In some implementations, the prefetch engine may also perform fault prediction analysis on the code that it has prefetched from flash, thereby mitigating downstream effects caused by faults. In the same or other implementations, the prefetch engine may also perform fault prediction analysis on code that was not prefetched, but rather fetched in response to a CPU request.

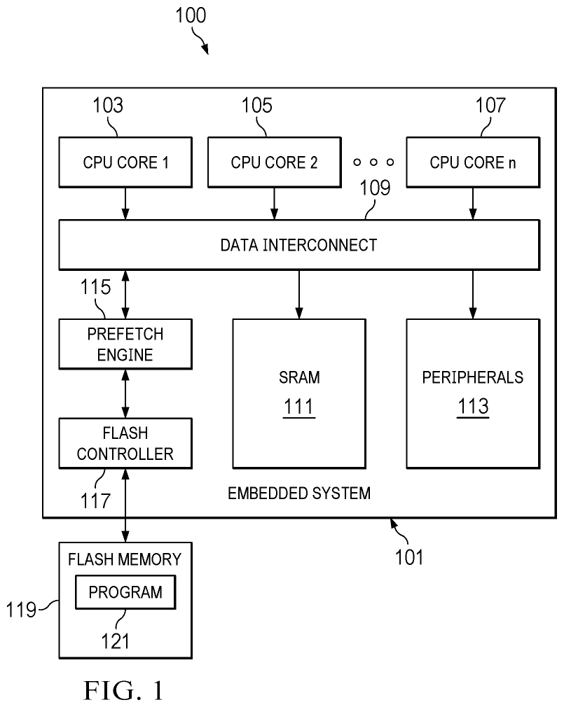

Turning now to the figures, FIG. 1 illustrates operational environment 100 in an implementation. Operational environment 100 includes embedded system 101 and flash memory 119. Operational environment 100 may be representative of a variety of contexts, such as for example automotive or industrial environments. Embedded system 101 is representative of a microcontroller unit (MCU) capable of executing program code to perform a designated task. For example, in the automotive context, embedded system 101 may provide various safety features such as airbag deployment, anti-lock braking, or tire-pressure monitoring. Embedded system 101 includes central processing unit (CPU) cores 103, 105, and 107, data interconnect 109, SRAM 111, peripherals 113, prefetch engine 115, and flash controller 117.

CPU cores 103, 105 and 107 are representative of processing resources (e.g., processor cores and/or groups thereof with or without supporting circuitry) which require access to memory to perform an associated function. CPU cores 103, 105, and 107 execute program code stored by SRAM 111 and flash memory 119, or just flash memory 119. For instance, a given program may be partially executed from both flash memory 119 and SRAM 111 or executed-in-place entirely from flash memory 119. It should be noted that where programs are executed from is a matter of design considerations such as performance and latency requirements.

CPU cores 103-107 communicate via data interconnect 109 with SRAM 111, peripherals 113, and prefetch engine 115. CPU cores 103-107 may obtain program code and data from SRAM 111 in the context of executing a program application that is executed from SRAM 111 entirely or partially. CPU cores 103-107 obtain output from peripherals 113, examples of which include general purpose input-output (GPIO) controllers, timers, analog to digital converters (ADCs), serial communication controllers, and other devices of the like. CPU cores 103-107 obtain program code and data from prefetch engine 115 in the context of executing a program application either entirely or partially from flash memory 119.

Prefetch engine 115 is representative of circuitry capable of analyzing branch logic in program code to identify a block of code to prefetch from flash memory 119. A block of program code may be representative of a burst of code, a page of code, or the like. A burst of code may be, for example, 32 or 64 bytes of data, or any other size that matches the size of a CPU cache line. A page of code may consist of multiple bursts of code and is therefore multiple times as large as a burst. For example, a page may hold 1, 2, or 4 kilobytes of code. Prefetch engine 115 prefetches program code in terms of bursts or pages, while supplying program code to CPU cores 103-107 in terms of bursts. In an implementation, the size of the burst is dependent on the cache line size of the CPU requesting the burst. For example, if the cache line size of the CPU requesting the burst is 16, 32, or 64 bytes, then the size of the burst will also be 16, 32, or 64 bytes.

Prefetch engine 115 communicates with flash controller 117 to prefetch blocks of code from flash memory 117. In an implementation, prefetch engine 115 communicates with flash controller 117 when flash controller 117 is idle. Prefetch engine 115 stores prefetched program code within an internal memory buffer. The internal memory buffer stores prefetched program code in terms of pages. Each page stores multiple bursts of code. When requested, prefetch engine 115 interfaces with the internal memory buffer to supply a requested burst to the cache of the requesting CPU (e.g., one or more of CPU cores 103-107) via data interconnect 109.

Flash controller 117 is representative of circuitry capable of retrieving blocks of program code from flash memory 119. Flash memory 119 is representative of a long-term memory which stores program code (e.g., program 121) thereon and from which program code may be executed “in-place”. Program 121 is representative of program code with which embedded system 101 performs a designated task. Flash controller 117 interfaces with flash memory 119 to provide blocks of program 121 to the memory buffer of prefetch engine 115. It should be noted that while flash memory 119 is illustrated as external with respect to embedded system 101, flash memory 119 may be internal to embedded system 101 in alternate implementations.

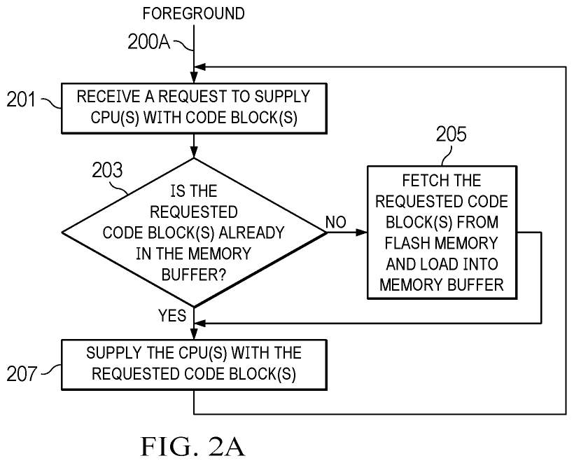

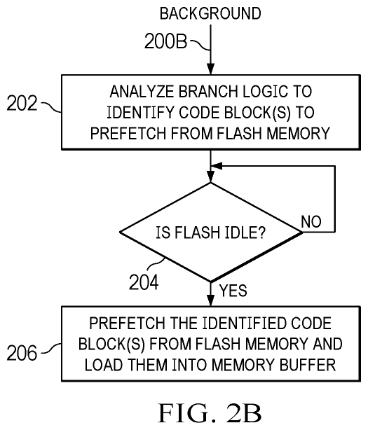

FIG. 2A illustrates request handling method 200A executed by prefetch engine 115 in response to requests for program code made by CPU cores 103-107. For the purposes of brevity, a single core of a single CPU (e.g., CPU core 103) will be discussed herein. This is not meant to limit the applications of CPU cores 105 and 107, but rather to provide an example.

Request handling method 200A is an example of a demand fetch and begins with prefetch engine 115 receiving a request to supply CPU core 103 with one or more code blocks (step 201). For example, prefetch engine 115 may receive a request to supply CPU core 103 with a burst of code. In response to receiving the request, prefetch engine 115 determines if the requested burst is already stored by the internal memory buffer of prefetch engine 115 (step 203).

If the requested burst is not already stored by the memory buffer, then prefetch engine 115 fetches the requested burst from flash memory 119 and loads the requested burst to the memory buffer (step 205). To fetch the requested burst, prefetch engine 115 interfaces with flash controller 117 to fetch the requested burst from flash memory 119. Once the requested burst has been identified within the memory buffer, prefetch engine 115 supplies CPU core 103 with the requested burst (step 207) via data interconnect 109.

FIG. 2B illustrates prefetch method 200B also executed by prefetch engine 115, but in the background with respect to request handling method 200A. To begin, prefetch engine 115 analyzes the branch logic of the current program code within the memory buffer to identify which code block(s) need to be prefetched next from flash memory 119 (step 202). Prefetch engine may prefetch bursts of code or pages of code from flash memory 119.

When prefetch engine 115 identifies the next code block to prefetch, prefetch engine 115 waits for flash controller 117 to be idle to make a request for the next code block (step 204). Once flash controller 117 is idle, prefetch engine 115 requests flash controller 117 to prefetch the next block of code from flash memory 119 and load the next code block to the memory buffer of prefetch engine 115 (step 206).

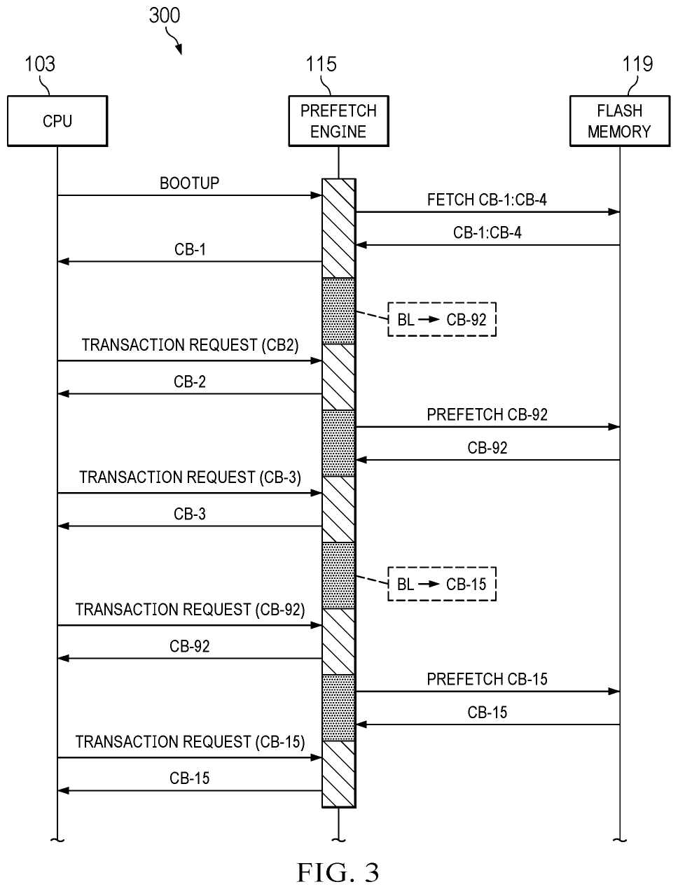

In FIG. 3, operational sequence 300 illustrates an application of request handling method 200A and prefetch method 200B with respect to the elements of FIG. 1. In the foreground, prefetch engine 115 performs request (e.g., demand) handling method 200A, as indicated by the cross-hatching sections of prefetch engine 115. In the background, prefetch engine 115 performs prefetch method 200B, as indicated by the dotted sections of prefetch engine 115. It should be noted that request handling method 200A takes priority over prefetch method 200B, such that prefetch engine 115 prioritizes servicing transaction requests over prefetching new code blocks.

To begin, CPU core 103 sends a request for bootup code to prefetch engine 115. Prefetch engine 115 receives the request and in response fetches a first page of program code from flash memory 119, such that the first page of code includes the burst of code which represents the boot-up code requested by CPU core 103. In an implementation, the first page of code includes the first four bursts of code stored by flash memory 119 (e.g., CB-1, CB-2, CB-3, and CB-4).

Upon fetching the first page of code, prefetch engine 115 loads the first page of code to its internal memory buffer. Prefetch engine 115 is unable to provide the first page of code to CPU core 103 due to the cache line size limitations of CPU core 103. In an implementation, the cache of CPU core 103 is only capable of storing a single burst of code at a time.

Next, prefetch engine 115 provides the burst representative of the bootup code (e.g., CB-1) to the cache of CPU core 103. CPU core 103 receives CB-1 and in response executes the code of CB-1. While CPU core 103 is executing, prefetch engine 115 analyzes the branch logic expressed in the bursts of the memory buffer (e.g., CB-2, CB-3, and CB-4) to determine if a current burst of the memory buffer branches to a burst of code that is not currently stored by the memory buffer. For example, prefetch engine 115 may determine that CB-2 branches to CB-3, a current burst of the memory buffer, but CB-3 branches to CB-92, a burst not currently stored by the memory buffer.

Prefetch engine 115 may prefetch new code blocks when it is not servicing requests generated by CPU core 103 and when there is available space within the memory buffer. For example, during the execution of CB-1, prefetch engine 115 determines that CB-3 branches to CB-92. Prior to prefetching CB-92, prefetch engine 115 must service the transaction request for CB-2. Upon supplying CB-2 to the cache of CPU core 103, prefetch engine 115 prefetches CB-92.

It should be noted that prefetch engine 115 prefetches CB-92 rather than sequentially prefetching CB-5. In linear prefetching schemes, CB-5 would have been prefetched next. Here, CB-5 is skipped because the branch logic indicates that the code of CB-3 branches to CB-92 instead of sequentially branching to CB-4 followed by CB-5. Advantageously, this improves processing times of CPU core 103 as prefetch engine 115 prefetches new code blocks based on branch logic rather than sequence. Thus, prefetch engine 115 is able to immediately supply the requested bursts to the cache of CPU core 103 rather than wasting execution cycles fetching the requested bursts from flash memory 119. For example, if prefetch engine 115 was to instead prefetch CB-5, then after the execution of CB-3 prefetch engine 115 must waste execution cycles discarding CB-5 from the memory buffer and fetching CB-92 from flash memory 119.

Upon loading CB-92 to the memory buffer, prefetch engine 115 analyzes CB-92 to identify branch logic within the burst of code. While performing the branch logic analysis, prefetch engine 115 receives a transaction request for CB-3. As the transaction request is representative of a foreground process (e.g., request handling method 200A), prefetch engine 115 halts the branch logic analysis and instead services the request for CB-3.

Once idle, prefetch engine 115 returns to the branch logic analysis of CB-92, where prefetch engine 115 determines that the code of CB-92 branches to the code of CB-15. Prior to prefetching CB-15, prefetch engine 115 must service the transaction request for CB-92. Upon supplying CB-92 to the cache of CPU core 103, prefetch engine 115 prefetches CB-15. After the execution of CB-92, CPU core 103 generates a transaction request for CB-15. As CB-15 has already been prefetched, prefetch engine 115 can immediately supply CB-15 to the cache of CPU core 103.

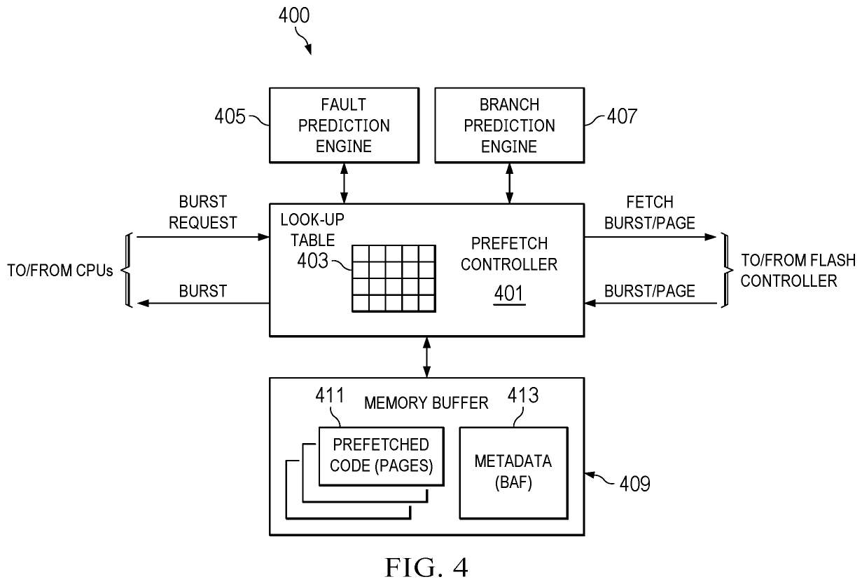

FIG. 4 illustrates prefetch system 400 in an implementation. Prefetch system 400 is an example implementation of the prefetch engine 115 of FIG. 1 and dynamically prefetches program code based on branch logic of the prefetched program code. Prefetch system 400 includes prefetch controller 401, fault prediction engine 405, branch prediction engine 407, and memory buffer 409. In an implementation, prefetch system 400 is representative of prefetch engine 115 of FIG. 1.

Prefetch controller 401 represents circuitry that controls the prefetching of program code from flash memory (not shown). Prefetch controller 401 interfaces with a flash controller (e.g., flash controller 117) to prefetch blocks of program code from flash memory. A block of program code may be representative of either a page of code or a burst of code, such that a page of code represents 1, 2, or 4 kilobytes of data, while a burst of code represents 32 or 64 bytes of data. In an implementation, prefetch controller 401 prefetches new blocks of code when the flash controller is idle, and the storage capacity of memory buffer 409 is not fully occupied. If neither of these criteria are met, then prefetch controller 401 must wait to prefetch new blocks of code.

Fault prediction engine 405 is representative of circuitry configured to detect and verify potential faults within bursts of program code. For example, fault prediction engine 405 may be representative of a finite state machine, a co-processor, a CPU, or the like. Prefetch controller 401 interfaces with fault prediction 405 to detect potential faults within prefetched blocks of code, as well as code blocks that are not prefetched but rather fetched in the normal course of operations. For example, fault prediction engine 405 may be capable of detecting memory faults based on an error correction code (ECC) process and/or a cyclic redundancy check (CRC) process. Beyond memory faults, fault prediction engine 405 may be capable of testing the validity of instructions. For instance, in an example associated with a predicted read operation, fault prediction engine 405 may read from a location identified by an instruction to confirm that the operation is valid.

Branch prediction engine 407 is representative of circuitry configured to detect branch logic within the program code of memory buffer 409. For example, branch prediction engine 407 may be representative of a coprocessor or CPU of like. Branch prediction engine 407 analyzes the bursts of memory buffer 409 to identify instructions that may change the flow of execution (e.g., branch, jump, loop, return, etc.) and to identify, for these instructions, whether these instructions may cause the flow of execution to change to a burst that is not currently stored by memory buffer 409. In the context of program code, the branch logic of a first burst of code may branch forward or backward in the program code. Meaning, the branch logic of the first burst of code may branch to a preceding burst of code, or a subsequent burst of code. Prefetch controller 401 interfaces with branch prediction engine 407 to determine the next burst (or page) to prefetch from flash memory.

Memory buffer 409 is representative of a memory configured to store pages of program code. Memory buffer 409 stores the pages of program code in terms of bursts, such that the size of each burst is equal to the cache line size of the CPUs (e.g., 32 or 64 bytes). Memory buffer 409 includes prefetched code 411 and metadata 413. Prefetched code 411 represents the pages of program code which have already been prefetched from flash memory. When loaded to memory buffer 409, the pages of prefetched code 411 are divided into bursts and tracked by metadata 413. Metadata 413 represents a set of burst available flags (BAFs) that tracks the availability of each burst within memory buffer 409. Prefetch controller references metadata 413 to determine if a requested burst is available (e.g., BAF=1) to be provided to the CPUs.

Look-up table 403 is representative of a table maintained by prefetch controller 401 that tracks the analytics of prefetched code 411. Look-up table 403 tracks which pages are represented by prefetched code 411, the addresses that correspond to each page, and how many times the CPUs request access to a page. Prefetch controller 401 references look-up table 403 to determine if the page associated with a requested burst is represented by prefetched code 411.

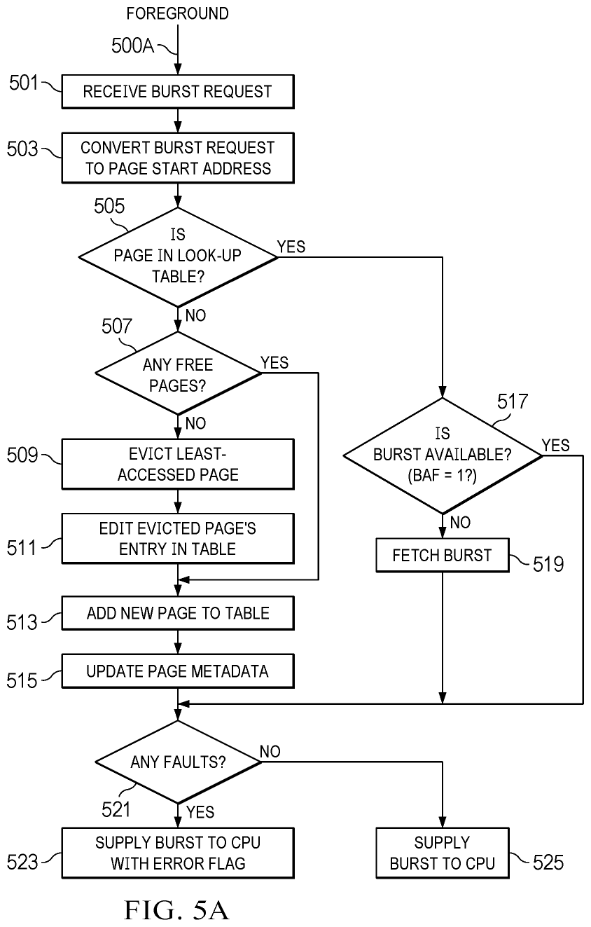

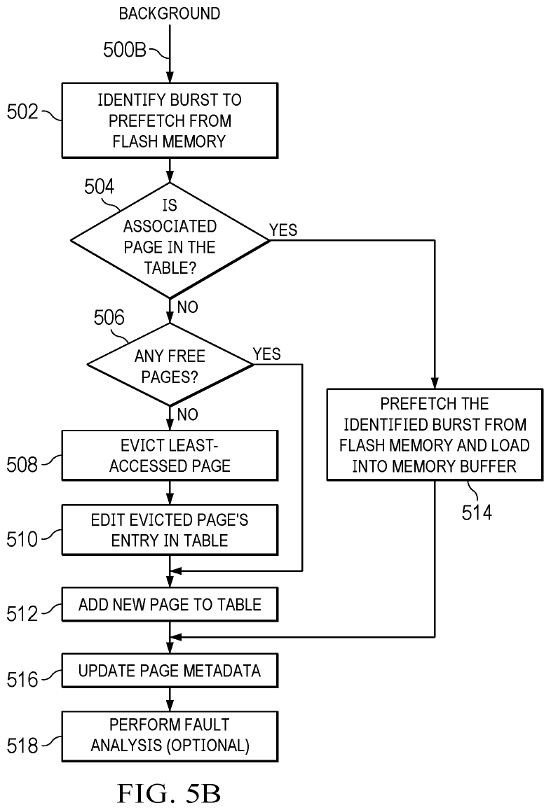

FIG. 5A illustrates burst request process 500A executed by prefetch controller 401 in response to the burst requests generated by the CPU cores. To begin, prefetch controller 401 receives a request for a burst of code (e.g., demand) (step 501) from the CPU cores. Upon receiving the request, prefetch controller 401 converts the request into a page start address (step 503) to identify the addresses associated with the requested burst.

Next, prefetch controller 401 determines if the addresses of the requested burst are represented by a page of look-up table 403 and thus whether the instructions of the burst are present in the memory buffer 409 (step 505). If not represented, prefetch controller 401 determines if there is any available space within memory buffer 409 for a new page of program code (step 507) such that the new page comprises the requested burst. When there is available space, prefetch controller 401 loads the new page to memory buffer 409 and updates look-up table 403 to describe the addresses of the new page (step 513). Alternatively, when there is no available space in memory buffer 409, prefetch controller 401 identifies the least accessed page via look-up table 403 and evicts said page from memory buffer 409 (step 509). Once evicted, prefetch controller 401 updates look-up table 403 to accurately represent the currently stored pages of memory buffer 409 (step 511). After creating space within memory buffer 409, prefetch controller 401 loads the new page to memory buffer 409 and updates look-up table 403 accordingly (step 513).

Once the new page is loaded, prefetch controller 401 updates metadata 413 to describe the availability of each burst within the new page (step 515) such that the burst available flag of the requested burst indicates that the burst is available (e.g., BAF=1). Prior to supplying the requested burst to the CPU cores, fault prediction engine 405 analyzes the requested burst for potential faults (step 521). If a potential fault is identified, prefetch controller 401 sets the potential fault flag and supplies the requested burst to the CPU cores (step 523). If a potential fault is not identified, prefetch controller 401 supplies the requested burst to the CPU cores (step 525). It should be noted that in this case fault prediction engine 405 is employed in the foreground, as the CPU cores currently require the requested burst to continue execution.

Alternatively, if the requested burst was originally represented by a page of look-up table 403, then prefetch controller 401 analyzes metadata 413 to determine the availability of the requested burst (step 517). If the requested burst is unavailable (e.g., BAF=0), then prefetch controller 401 instructs the flash controller to fetch the requested burst from flash memory and load the requested burst to memory buffer 409 (step 519). Once the requested burst is loaded, prefetch controller 401 employs fault prediction engine 405 to analyze the requested burst for potential faults (step 521). If a potential fault is identified, prefetch controller 401 sets the potential fault flag and supplies the requested burst to the CPU cores (step 523). If a potential fault is not identified, prefetch controller 401 simply supplies the requested burst to the CPU cores (step 525).

Alternatively, if the requested burst is available (e.g., BAF=1) within memory buffer 409, then prefetch controller 401 analyzes the output of fault prediction engine 405 to identify potential faults within the requested burst of code (step 521). It should be noted that in this case fault prediction engine 405 was able to perform fault analysis in the background, since the CPU cores did not require the requested burst at the time the fault analysis performed. If the output of fault analysis indicates a potential fault, then prefetch controller 401 sets the potential fault flag and supplies the requested burst to the CPU cores (step 523). Alternatively, if the output of the fault analysis does not indicate a potential fault, then prefetch controller 401 simply supplies the requested burst to the CPU cores (step 525).

FIG. 5B illustrates prefetch process 500B also executed by prefetch controller 401, but in the background with respect to burst request process 500A. To begin, branch prediction engine 407 identifies a burst of code to prefetch from flash memory (step 502). The burst of code may be prefetched in response to branch logic in another burst or any other suitable prefetch condition. When identified, prefetch controller 401 analyzes look-up table 403 to determine if the page associated with the identified burst is represented by look-up table 403 (step 504).

If the page associated with the identified burst is represented, then prefetch controller 401 prefetches the identified burst from flash memory and loads the burst to memory buffer 409 (step 514). After the identified burst is loaded to memory buffer 409, prefetch controller 401 updates metadata 413 to indicate the availability of the identified burst (step 516).

Alternatively, if the page associated with the identified burst is not represented, prefetch controller 401 determines if there is any available space within memory buffer 409 for a new page (step 506) such that the new page comprises the identified burst. When there is available space, prefetch controller 401 prefetches the new page, loads the new page to memory buffer 409, and updates look-up table 403 accordingly (step 512). Alternatively, when there is no available space, prefetch controller 401 identifies the least accessed page via look-up table 403 and evicts said page from memory buffer 409 (step 508). Once evicted, prefetch controller 401 updates look-up table 403 to accurately represent the currently stored pages of memory buffer 409 (step 510). Next, prefetch controller 401 prefetches the new page, loads the new page to memory buffer 409, and updates look-up table 403 accordingly (step 512). After the new page is loaded to memory buffer 409, prefetch controller 401 updates metadata 413 to describe the availability of each burst of code within the new page (step 516) such that the BAF of the identified burst indicates that the burst is available (e.g., BAF=1).

Optionally, prefetch controller 401 may employ fault prediction engine 405 to perform fault analysis once the identified burst is available within memory buffer 409 (step 518). Fault prediction engine 405 sets the potential fault flag for the identified burst if a potential fault is identified. In an implementation, if fault prediction engine 405 is employed in the background, then it is not required to perform fault analysis in the foreground of operation.

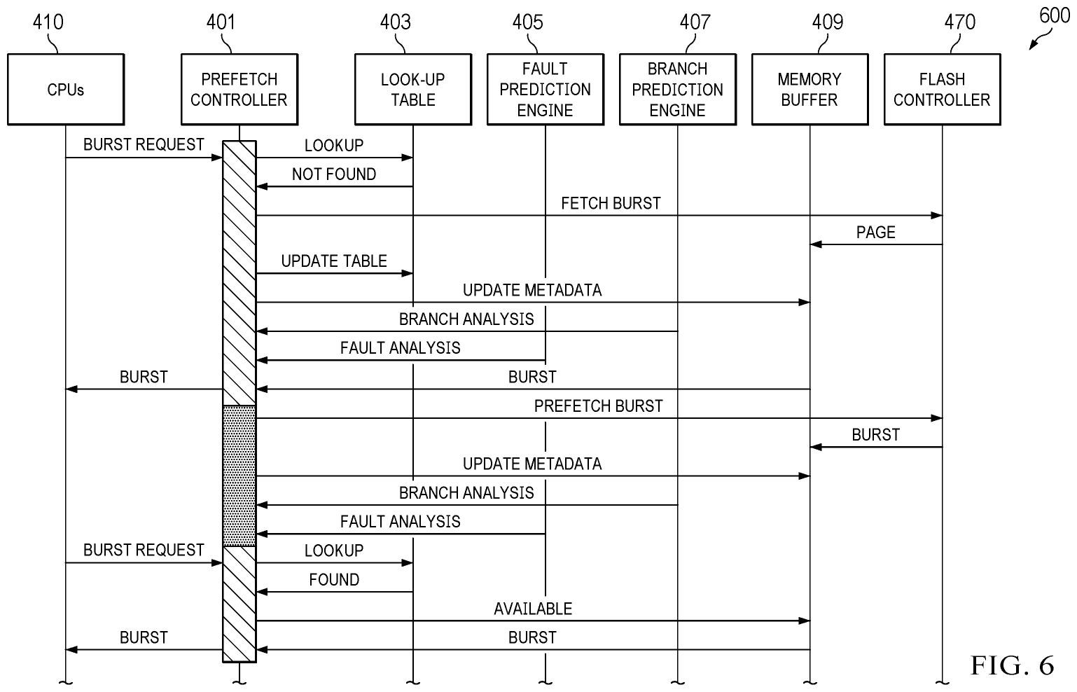

In FIG. 6, operational sequence 600 illustrates an application of burst request process 500A and prefetch process 500B with respect to the elements of FIG. 4 with the addition of CPUs 410 (e.g., one or more of CPU cores 103, 105, and 107) and flash controller 470 (e.g., flash controller 117). In the foreground, prefetch controller 401 performs burst request process 500A, as indicated by the cross-hatching sections of prefetch controller 401. In the background, prefetch controller 401 performs prefetch process 500B, as indicated by the dotted sections of prefetch controller 401. It should be noted that burst request process 500A takes priority over prefetch process 500B, such that prefetch controller 401 prioritizes servicing burst requests over prefetching new blocks of code.

In a brief example, prior to operation, memory buffer 409 is empty. Meaning, prefetch controller 401 has yet to prefetch any code from flash memory. To begin operation, CPUs 410 send a boot-up signal to prefetch controller 401.

In an implementation, the boot-up signal is representative of a request for prefetch controller 401 to fetch a first burst of boot-up code from flash memory. Upon receiving the request, prefetch controller 401 interfaces with flash controller 470 to fetch the requested burst of boot-up code and provide the burst to CPUs 410. Prefetch controller 401 may perform a fetch for the requested burst of boot-up code, rather than prefetch, as CPUs 410 may be stalled waiting for the burst to continue operation. While CPUs 410 are executing the boot-up code, prefetch controller 401 instructs flash controller 470 to prefetch a first set of pages from flash memory. Prefetch controller 401 may be able to prefetch the first set of pages, rather than fetch, when CPUs 410 do not currently require the program code represented by the first set of pages to continue operating.

In another implementation, the boot-up signal is representative of an instruction to prefetch the first set of pages from flash memory. Upon receiving the instruction, prefetch controller 401 interfaces flash controller 470 to prefetch the pages associated with the instruction. Prefetch controller 401 stores the pages in memory buffer 409. When stored, memory buffer 409 divides the pages into bursts, which may be supplied to the caches of CPUs 410.

While prefetch controller 401 prefetches the first set of pages, look-up table 403 is updated to describe the addresses corresponding to the first set of pages. Similarly, as memory buffer 409 stores the first set of pages, the metadata is updated to describe the availability of each burst represented by memory buffer 409. It should be noted that, during the course of operation, look-up table 403 and the metadata are updated to describe the current program code of memory buffer 409.

In the foreground of operation, prefetch controller 401 services burst requests generated by CPUs 410. For example, when prefetch controller 401 receives a request for a burst of code, prefetch controller 401 analyzes look-up table 403 to determine if the page associated with the requested burst is currently represented by a page of look-up table 403. If the requested burst is represented, then prefetch controller 401 analyzes the BAF associated with the burst to determine the burst's availability. If the BAF of the requested burst indicates that the burst is available (e.g., BAF=1), then prefetch controller 401 supplies the requested burst to CPUs 410.

Prior to supplying a requested burst to CPUs 410, fault prediction engine 405 analyzes the program code of the requested burst to identify any potential faults. If fault prediction engine 405 detects a potential fault within the requested burst of code, then fault prediction engine 405 sets a potential fault flag for CPUs 410. During execution of the potentially faulted burst, CPUs 410 recruit fault prediction engine 405 to verify the potential fault. For example, if the requested burst is representative of a memory read instruction, then fault prediction engine 405 examines the parity and ECC bits corresponding to the memory read. Alternatively, if the requested burst is representative of a memory write instruction, then fault prediction engine 405 performs a comparison operation to ensure the memory write was successfully executed. Finally, if the requested burst is representative of a computational operation, then fault prediction engine 405 performs the computational operation to confirm the results of CPUs 410. In an implementation, if fault prediction engine 405 verifies a potential memory read fault, memory write fault, or computational fault, then fault prediction engine 405 instructs CPUs 410 to halt execution. Alternatively, if the potential fault is not verified, then fault prediction engine 405 allows CPUs 410 to continue execution.

In the background of operation, prefetch controller 401 supplements memory buffer 409 with new blocks of program code based on the output of branch prediction engine 407. Prefetch controller 401 prioritizes which block of code to prefetch based on the requests of CPUs 410. For example, CPUs 410 may request for a burst of code which branches to a next burst not currently stored by memory buffer 409. Upon supplying the requested burst to CPUs 410, prefetch controller 401 waits for flash controller 470 to be idle to prefetch the next burst of code. When CPUs 410 eventually request for the next burst of code, prefetch controller 401 is able to supply the next burst immediately.

To begin operational sequence 600, CPUs 410 send a burst request to prefetch controller 401. Prefetch controller 401 receives the request and in response analyzes look-up table 403 to determine if the addresses of the requested burst are represented by a page in look-up table 403. After prefetch controller 401 determines that the addresses are not represented, prefetch controller 401 examines the storage space of memory 409 to determine if there is enough space for a new page of code.

Upon determining there is enough storage space within memory buffer 409, prefetch controller 401 sends a request to flash controller 470 to fetch a new page of code from flash memory such that the new page of code comprises the requested burst. Upon receiving the request, flash controller 470 loads the requested page of code to memory buffer 409. In response, prefetch controller 401 updates look-up table 403 to describe the addresses associated with the page of code. Prefetch controller 401 also updates the metadata to describe the availability of the bursts within the page.

Next, prefetch controller 401 employs fault prediction engine 405 and branch prediction engine 407 to perform an analysis on the requested burst of code. Prefetch controller 401 employs fault prediction engine 405 to detect potential faults within the requested burst of code. Prefetch controller 401 employs branch prediction engine 407 to identify branch logic within the requested burst of code. It should be noted that fault prediction engine 405 and branch prediction engine 407 are employed in the foreground, since the requested burst was not yet stored by memory buffer 409. If the requested burst had already been stored by memory buffer 409, then fault prediction engine 405 and branch prediction engine 407 may perform their analysis in the background.

Fault prediction engine 405 and branch prediction engine 407 provide the output of their analysis to prefetch controller 401. For example, the output of fault prediction engine 405 may be indicative of a potential fault within the requested burst of code, while the output of branch prediction engine 407 may be indicative of branch logic within the requested burst of code. In an implementation, if the output of fault prediction engine 405 is indicative of a potential fault, then prefetch controller 401 sets a potential fault flag for CPUs 410 to note during execution of the requested burst.

After receiving output regarding the fault analysis and branch analysis of the requested burst, prefetch controller 401 retrieves the requested burst from memory buffer 409 and provides the requested burst to CPUs 410. In response, CPUs 410 begin execution of the requested burst. If a potential fault was detected during the fault analysis, CPUs 410 employ fault prediction engine 405 to verify the potential fault.

During execution of the requested burst, prefetch controller 401 analyzes the output of branch prediction engine 407 to determine a next burst to prefetch from flash memory. The next burst may be prefetched in response to branch logic in another burst or any other suitable prefetch condition. In an implementation, prefetch controller 401 determines the next burst to prefetch based on the addresses of the originally requested burst. For example, if the originally requested burst corresponds to a first set of addresses, prefetch controller 401 will prefetch the burst which corresponds to the next set of addresses, such that the next set of addresses directly follows the first set of addresses in the context of the program code.

In an implementation, prefetch controller 401 requests flash controller 470 to prefetch the next burst when flash controller 470 is idle. Flash controller 470 receives the request and in response prefetches the next burst of code from flash memory. It should be noted that flash controller 470 is able to prefetch the next burst, rather than fetch, as CPUs 410 do not currently require the code of the next burst to continue execution.

When loaded to memory buffer 409, prefetch controller 401 updates the metadata to describe the availability of the burst. Further, prefetch controller 401 employs fault prediction engine 405 and branch prediction engine 407 to perform an analysis on the burst. It should be noted that fault prediction engine 405 and branch prediction engine 407 are employed in the background as CPUs 415 do not currently require the burst for execution. Fault prediction engine 405 and branch prediction engine 407 provide output of their analysis to prefetch controller 401.

Upon execution of the first burst, CPUs 410 generate a request for a second burst of code. Prefetch controller 401 receives the request and in response references look-up table 403 to determine if the addresses associated with the second burst are represented by a page of look-up table 403. After prefetch controller 401 determines that the addresses are represented, prefetch controller 401 determines if the burst is currently available. As the burst is available, prefetch controller 401 supplies the second burst of code to CPUs 410.

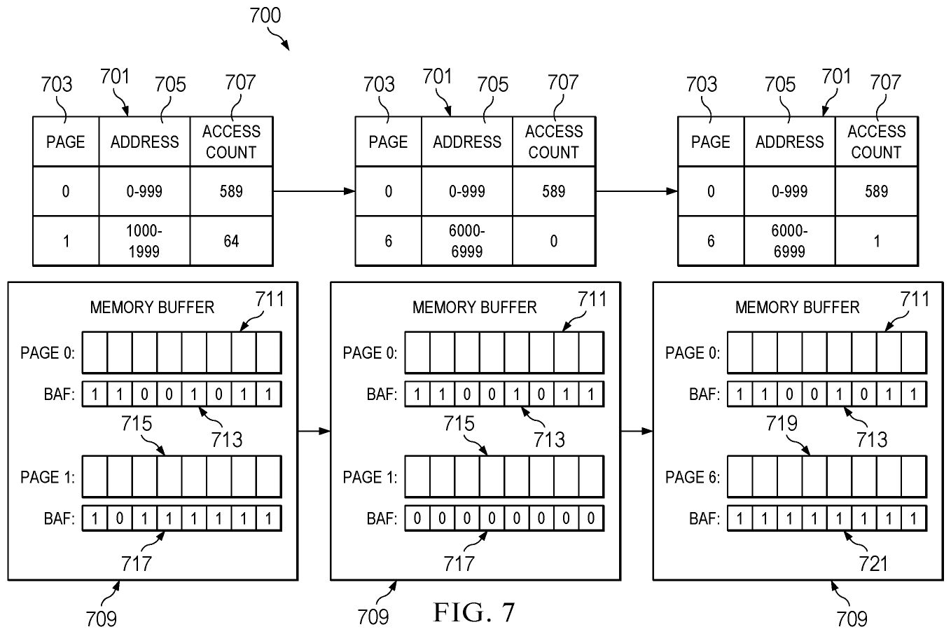

FIG. 7 illustrates an operational scenario for the components of a controller configured to prefetch program code for an associated system, herein referred to as operational scenario 700. For example, operational scenario 700 may represent the components of prefetch system 400. Operational scenario 700 includes look-up table 701 (e.g., look-up table 403) and memory buffer 709 (e.g., memory buffer 409).

Memory buffer 709 is representative of a memory configured to store pages of program code. A page of program code may be representative of 1, 2, or 4 kilobytes of data. Memory buffer 709 stores the pages in terms of bursts such that the size of each burst of code is equal to the cache line size of the associated system (e.g., 32 or 64 bytes). Memory buffer 709 includes, but is not limited to, page 711, metadata 713, page 715, and metadata 717. flash memory and loaded to memory buffer 709. When loaded, pages 711 and 715 are divided into bursts and monitored by metadata 713 and metadata 717 respectively. Metadata 713 and metadata 717 represent the burst available flags corresponding to each burst of pages 711 and 715. A burst is considered to be available if the burst available flag is set (e.g., BAF=1), else the burst is considered to be unavailable (e.g., BAF=0).

Look-up table 701 represents a table that describes the current data of memory buffer 709. Look-up table 701 includes, but is not limited to, page column 703, address column 705, and access column 707. Page column 703 tracks the pages currently stored by memory buffer 709 (e.g., page 711 and page 715) while address column 705 tracks the addresses of those pages. Page column 703 and address column 705 are updated when a page is evicted from or added to memory buffer 709. Alternatively, access column 707 tracks the number of times each page is accessed by the associated system. For example, in the context of FIG. 4, access column 707 tracks the number of times the CPUs access a specific page within memory buffer 409.

In a first stage of operation, the controller associated with look-up table 701 and memory buffer 709 receives a request for a first burst of code. Upon receiving the request, the controller examines look-up table 701 to determine if the addresses associated with the request are represented by address column 705. If represented, the controller next examines the appropriate metadata to determine if the requested burst is currently available within memory buffer 709. If the requested burst is available, then the controller provides the requested burst to a cache of the associated system.

Alternatively, if the addresses of the requested burst are not represented by look-up table 701, or the requested burst is unavailable within memory buffer 709, then the controller determines which page should be evited from memory buffer 709 to make room for a next page which comprises the requested burst. To determine which page to evict from memory buffer 709, the controller analyzes look-up table 701 to determine least accessed page (e.g., page 715).

In a second stage of operation, upon identifying the least accessed page, the controller first updates the metadata corresponding to the least accessed page to indicate the bursts of the page are no longer available. Next, the controller updates look-up table 701 to describe the addresses of the next page which will be prefetched from flash memory. Finally, the controller evicts the least accessed page from memory buffer 709.

In a final stage of operation, the controller causes the next page, page 719, to be loaded to memory buffer 709. In an implementation the controller is coupled to a flash controller configured to retrieve pages of program code from flash memory. In operation, the controller sends a request for page 719 to the flash controller. In response the flash controller loads page 719 to memory buffer 709. When loaded to memory buffer 709, metadata 721 of page 719 is updated to indicate the bursts of page 719 are available. Once the requested burst is considered available, the controller supplies the requested burst to a cache of the associated system.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
using prefetch circuitry:
analyzing branch logic in program code to identify a block of code to prefetch from a memory;
causing the block of code to be prefetched from the memory and loaded into a memory buffer;
receiving a request to supply processing circuitry with the block of code;
determining that the block of code has already been fetched and loaded in the memory buffer; and
causing the block of code to be supplied to the processing circuitry.

2. The method of claim 1, wherein the method further comprises, using the prefetch circuitry:
receiving a different request to supply the processing circuitry with a different block of code;
determining that the different block of code is not in the memory buffer; and
causing the different block of code to be fetched from the memory and supplied to the processing circuitry.

3. The method of claim 2 wherein causing the block of code to be prefetched from the memory comprises the prefetch circuitry monitoring for when flash control circuitry is idle and instructing the flash control circuitry to read out the block of code from the memory only when the flash controller is idle.

4. The method of claim 1 wherein analyzing the branch logic in the program code to identify the block of code comprises analyzing branch logic in a preceding block of code already in the memory buffer, wherein the branch logic indicates a pathway through the program code that branches from the preceding block of code to the block of code.

5. The method of claim 4 wherein the program code comprises pages of code, each divided into bursts, wherein the block of code comprises one burst of the code, wherein the preceding block of code comprises one or more other bursts of the code that, in an order of execution of the program code, precede the block of code.

6. The method of claim 5 wherein causing the block of code to be prefetched from the memory and loaded into a memory buffer occurs in response to a request to supply the processing circuitry with the preceding block of code, and wherein the memory comprises flash memory.

7. The method of claim 1 further comprising, using the prefetch circuitry, detecting a fault in the block of code, and in response, alerting the processing circuitry to the fault.

8. The method of claim 7 further comprising the processing circuitry, in response to being alerted to the fault, directing the prefetch circuitry to verify the fault.

9. A system comprising:
processing circuitry configured to execute program code; and
prefetch circuitry coupled to the processing circuitry and configured to:
analyze branch logic in the program code to identify a block of code to prefetch from a memory;
cause the block of code to be prefetched from the memory and loaded into a memory buffer;
receive a request to supply the processing circuitry with the block of code;
determine that the block of code is already in the memory buffer; and
cause the block of code to be supplied to the processing circuitry.

10. The system of claim 9 wherein the prefetch circuitry is further configured to:
receive a different request to supply the processing circuitry with a different block of code;
determine that the different block of code is not in the memory buffer; and
cause the different block of code to be fetched from the memory and supplied to the processing circuitry.

11. The system of claim 9 wherein, to analyze the branch logic in the program code to identify the block of code, the prefetch circuitry is configured to analyze branch logic in a preceding block of code already in the memory buffer, wherein the branch logic indicates a pathway through the program code that branches from the preceding block of code to the block of code.

12. The system of claim 11 wherein the program code comprises pages of code, each divided into bursts, wherein the block of code comprises one burst of the code, and wherein the preceding block of code comprises one or more other bursts of the code that, in an order of execution of the program code, precede the block of code.

13. The system of claim 12 wherein the prefetch circuitry causes the block of code to be prefetched from the memory and loaded into the memory buffer in response to the processing circuitry requesting the preceding block of code and wherein the memory comprises flash memory.

14. The system of claim 9 wherein the prefetch circuitry is further configured to monitor for when flash control circuitry associated with the memory is idle, and wherein the prefetch circuitry causes the block of code to be prefetched from the memory only when the flash control circuitry is idle.

15. The system of claim 9 wherein the prefetch circuitry is further configured to detect a fault in the block of code requested by the processing circuitry, and in response, alert the processing circuitry to the fault.

16. The system of claim 15 wherein the processing circuitry is further configured to, in response to being alerted to the fault, direct the prefetch circuitry to verify the fault.

17. A circuit comprising:
prefetch control circuitry;
branch prediction circuitry; and
fault prediction circuitry;
wherein the branch prediction circuitry is configured to analyze branch logic in program code to identify a block of code to prefetch from memory;
wherein the prefetch control circuitry is configured to:
cause the block of code to be prefetched from the memory and loaded into a memory buffer; and
receive a request by processing circuitry for the block of code; and
cause the block of code to be supplied to the processing circuitry; and
wherein the fault prediction circuitry is configured to:
detect a fault in the block of code requested by the processing circuitry; and
alert the processing circuitry to the fault.

18. The circuit of claim 17 wherein, to analyze the branch logic in the program code to identify the block of code, the branch prediction circuitry is configured to analyze branch logic in a preceding block of code already in the memory buffer, wherein the branch logic indicates a pathway through the code that branches from the preceding block of code to the block of code.

19. The circuit of claim 18 wherein the code comprises pages of code, each divided into bursts, wherein the block of code comprises one burst of the code, and wherein the preceding block of code comprises one or more other bursts of the code that, in an order of execution of the program code, precede the block of code.

20. The circuit of claim 19 wherein the prefetch control circuitry causes the block of code to be prefetched from the memory and loaded into a memory buffer in response to the processing circuitry requesting the preceding block of code, and wherein the memory comprises flash memory.
